(19) United States
(12) Patent Application Publication
(10) Pub. No.: US 2016/0093841 A1
(43) Pub. Date: Mar. 31, 2016

(54) ENERGY STORAGE DEVICE AND MANUFACTURING METHOD OF THE SAME

(71) Applicant: GS Yuasa International Ltd., Kyoto-shi (JP)

(72) Inventors: Hideto WATANABE, Kyoto (JP); Manabu KANEMOTO, Kyoto (JP); Daisuke OKUDA, Kyoto (JP); Mitsuhiro KODAMA, Kyoto (JP)

(21) Appl. No.: 14/865,995

(22) Filed: Sep. 25, 2015

(30) Foreign Application Priority Data
Sep. 30, 2014 (JP) 2014-200745

(51) Int. Cl. H01M 2/08; H01M 2/04; H01M 2/02

(52) U.S. Cl. CPC H01M 2/08; H01M 2/022; H01M 2/0404; H01M 2220/30

(57) ABSTRACT

There is provided an energy storage device including: an electrode body; a lid portion; and a case main body having a body portion in a shape of a container which is open on one end side and for housing the electrode body inside itself and a sealing portion for surrounding and retaining the lid portion from an outer periphery on the opening side of the body portion, wherein an outside diameter of the sealing portion is smaller than an outside diameter of the body portion.

### CROSS-REFERENCE TO RELATED APPLICATIONS

This application claims the benefit of Japanese patent application No. 2014-200745, filed on Sep. 30, 2014, and No. 2014-200690, filed on Sep. 30, 2014, which are incorporated by reference.

### FIELD

The present invention relates to a technique for a structure of a case of an energy storage device.

### BACKGROUND

For example, a battery such as an alkaline secondary battery is manufactured as follows. In other words, a case of the battery is formed by putting an electrode body into a cylindrical case main body which is open at one end and closed at the other end and sealing an opening portion of the case main body with a lid. Then, a diameter reducing process in which the case of the battery is press-fitted into and caused to pass through an annular jig is carried out to manufacture the cases with regular outside diameters (see Japanese patent application No. 10-321198).

The case main body of the prior-art battery has a body portion for housing the electrode body and a sealing portion for surrounding and retaining the lid from an outer periphery, which have the same outside diameters. Therefore, an external force for the diameter reduction is applied not only to the body portion of the case main body but also to the sealing portion in the diameter reducing process described above. As a result, excessive external force acts on packing at the sealing portion, which reduces sealing performance.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present description will disclose a technique for preventing the reduction in the sealing performance of the case main body of the energy storage device due to undergoing of the diameter reducing process.

An energy storage device according to an aspect of the present invention includes: an electrode body; a lid portion; and a case main body having a body portion in a shape of a container which is open on one end side and for housing the electrode body inside itself and a sealing portion for surrounding and retaining the lid portion from an outer periphery on the opening side of the body portion, wherein an outside diameter of the sealing portion is smaller than an outside diameter of the body portion.

### BRIEF DESCRIPTION OF DRAWINGS

The foregoing and other features of the present invention will become apparent from the following description and drawings of an illustrative embodiment of the invention in which:

FIG. 1 is a vertical sectional view of a battery according to an embodiment.

FIG. 2 is a top view of a battery case.

FIG. 3 is an enlarged sectional view of a sealing portion of the battery case.

FIG. 4 is a schematic diagram showing a state of a battery case in a diameter reducing process in a comparative example.

FIG. 5 is a schematic diagram showing a state of the battery case in a. diameter reducing process in the embodiment.

### DESCRIPTION OF EMBODIMENTS

According to an aspect of the present invention, there is provided an energy storage device including: an electrode body; a lid portion; and a case main body having a body portion in a shape of a container which is open on one end side and for housing the electrode body inside itself and a sealing portion for surrounding and retaining the lid portion from an outer periphery on the opening side of the body portion, wherein an outside diameter of the sealing portion is smaller than an outside diameter of the body portion.

In the energy storage device, an end portion of the body portion close to the sealing portion may protrude toward the sealing portion.

### Embodiment

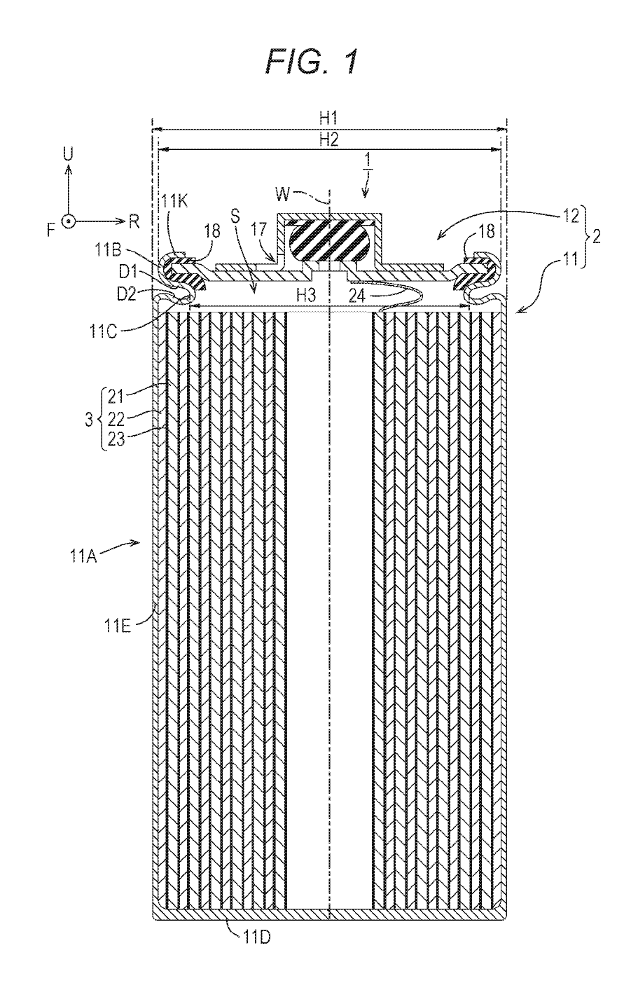

A battery 1 according to an embodiment will be described with reference to FIGS. 1 to 5. The battery 1 is an example of the energy storage device and is an alkaline secondary battery such as a nickel-metal hydride rechargeable battery. In the following description, a front side is defined as front side F of the battery 1, a right side is defined as right side R of the battery 1, and an upper side is defined, as upper side U of the battery 1 in FIG. 1.

### Structure of Battery

As shown in FIG. 1, the battery 1 includes a battery case 2 and an electrode body 3 housed in the battery case 2. The battery case 2 is in a shape of a circular cylindrical container which is long in a vertical direction, for example, as shown in FIG. 1. The battery case 2 includes a case main body 11 and a lid portion 12 and has a housing space S for housing the electrode body 3 inside itself.

The lid portion 12 is electrically connected to a positive electrode plate 21 (described later) by a connecting terminal 24 having elasticity and functions as a positive electrode terminal of the battery 1. The entire lid portion 12 is in a disc shape. The lid portion 12 is provided with a safety valve 17 so that gas in the battery case 2 can be released outside by the safety valve 17 when internal pressure in the battery case 2 reaches or exceeds a predetermined value.

The case main body 11 has a nickel plated surface and a negative electrode plate 22 (described later) is electrically connected to the case main body 11 so that the case main body 11 functions as a negative electrode terminal of the battery 1. The case main body 11 is in a shape of a circular cylindrical container which is open at one end (upper end) in a longitudinal direction of the battery case 2 (the vertical direction in FIG. 1) and closed at the other end (lower end). A central axis of the case main body 11 may be hereinafter referred to as a central axis W. The case main body 11 is formed integrally by drawing a metal plate, for example, and has a body portion 11A, a sealing portion 11B, and a constricted portion 11C which will be described later in detail.

The body portion 11A is a portion of the case main body 11 and for housing the electrode body 3 and includes a disc-shaped closed portion 11D and a circular cylindrical peripheral wall portion 11E. The peripheral wall portion 11E is in the circular cylindrical shape and integrally continuous and rising from an outer peripheral edge of the closed portion 11D and forms a side wall of the case main body 11 along the central axis W. The closed portion 11D forms a bottom portion of the case main body 11. An upper end of the peripheral wall portion 11E, i.e., an upper end of the body portion 11A is continuous with the constricted portion 11C. The body portion 11A is in a waistless shape with a uniform outside diameter throughout its length. An outside diameter of the body portion 11A will be hereinafter referred to as an outside diameter H1.

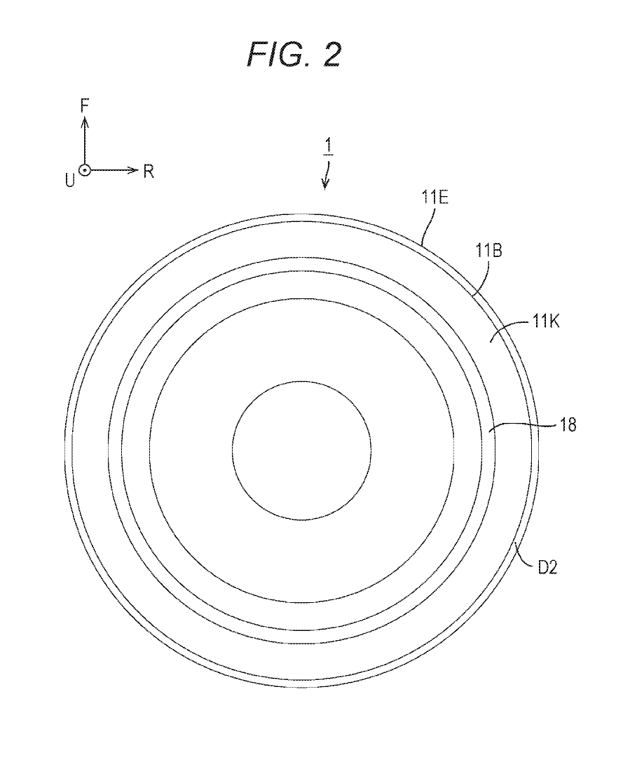

The sealing portion 11B is a portion open in a circular shape at the upper end of the case main body 11 to surround and retain the lid portion 12 from an outer periphery. To put it concretely, the sealing portion 11B is in an annular groove shape which is open on the whole on an inner periphery side and the lid portion 12 is fitted in the open portion with an insulating gasket 18 made of resin or the like interposed therebetween. An upper portion of the sealing portion 11B is bent inward by being caulked after the lid portion 12 is mounted from above. The upper portion will be hereinafter referred to as a caulked portion 11K. In this way, a peripheral edge portion of the lid portion 12 is surrounded and retained throughout its circumference by the sealing portion 11B from an outer periphery to seal the case main body 11 while keeping the lid portion 12 and the case main body 11 insulated from each other. As shown in FIG. 2, the sealing portion 11B has a maximum outside diameter H2 smaller than the outer diameter H1 of the body portion 11A throughout its circumference.

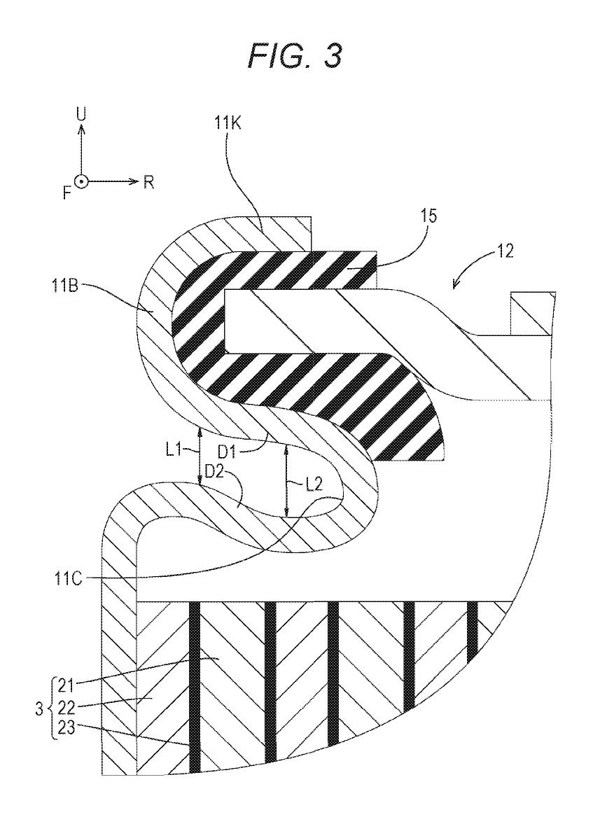

The constricted portion 11C is positioned between the body portion 11A and the sealing portion 11B and is in a groove shape open on an outer periphery side as shown in FIG. 3 and has paired wall portions D1 and D2 facing each other in the vertical direction. The wall portion D1 out of the paired wall portions D1 and D2 and positioned on an upper side and the above-described caulked portion 11K of the sealing portion 11B pinch the peripheral edge portion of the lid portion 12 from below and above with the gasket 18 interposed therebetween to thereby keep the sealing portion 11B in a sealed state. The wall portion D1 is inclined in such a direction as to separate from the sealing portion 11B (i.e., downward in FIGS. 1 and 3) as it extends toward the central axis W of the case main body 11.

On the other hand, at least a portion of the wall portion D2 out of the paired wall portions D1 and D2 and positioned on a lower side is inclined in such a direction as to separate from the sealing portion 11B as it extends toward the central axis W of the case main body 11. As a result, an end portion (an upper end portion in the drawings) of the body portion 11A close to the sealing portion 11B protrudes toward the sealing portion 11B (upward) and curves at the constricted portion 11C to be continuous with the wall portion D2 of the constricted portion 11C. In other words, the wall portion D2 curves to protrude upward from the body portion 11A and then curves to be parallel to the lid portion 12 as it extends toward the central axis W. Therefore, a clearance, in a direction along the central axis W of the case main body 11, of the groove shape of the constructed portion 11C is larger on a back side than on an opening side. To put it concretely, a clearance L1 of an inlet of the opening of the constricted portion 11C is smaller than a clearance L2 on the back side.

The electrode body 3 is housed in the housing space S in the battery case 2. The electrode body 3 is formed by winding the positive electrode plate 21, a negative electrode plate 22, and a separator 23 including electrolyte solution and disposed between the positive electrode plate 21 and the negative electrode plate 22 into a spirally wound shape about a winding axis along the axial direction W of the case main body 11, for example.

The positive electrode plate 21 is formed by applying positive active material such as a mixture of nickel hydride and a cobalt compound on a positive electrode metal plate such as foamed nickel, for example. The negative electrode plate 22 is formed by applying negative active material such as cadmium powder and hydrogen storage alloy powder on a negative electrode metal plate such as a nickel plated perforated steel plate in a flat plate shape, for example. The separator 23 is formed by polyolefin nonwoven fabric, for example. The separator 23 is impregnated with the electrolyte solution mainly including potassium hydroxide or sodium hydroxide.

### Effects of the Present Embodiment

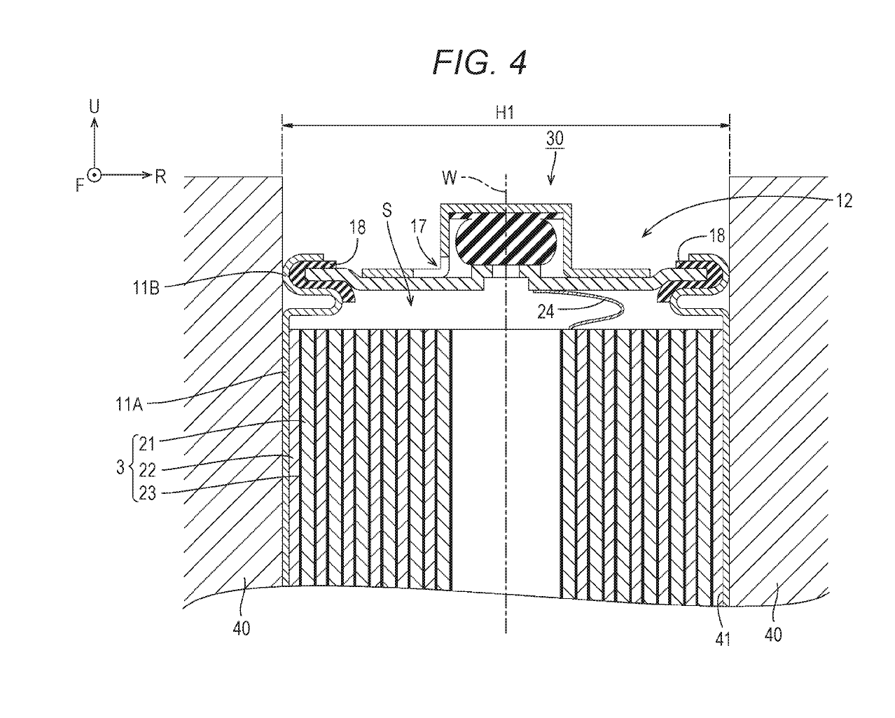

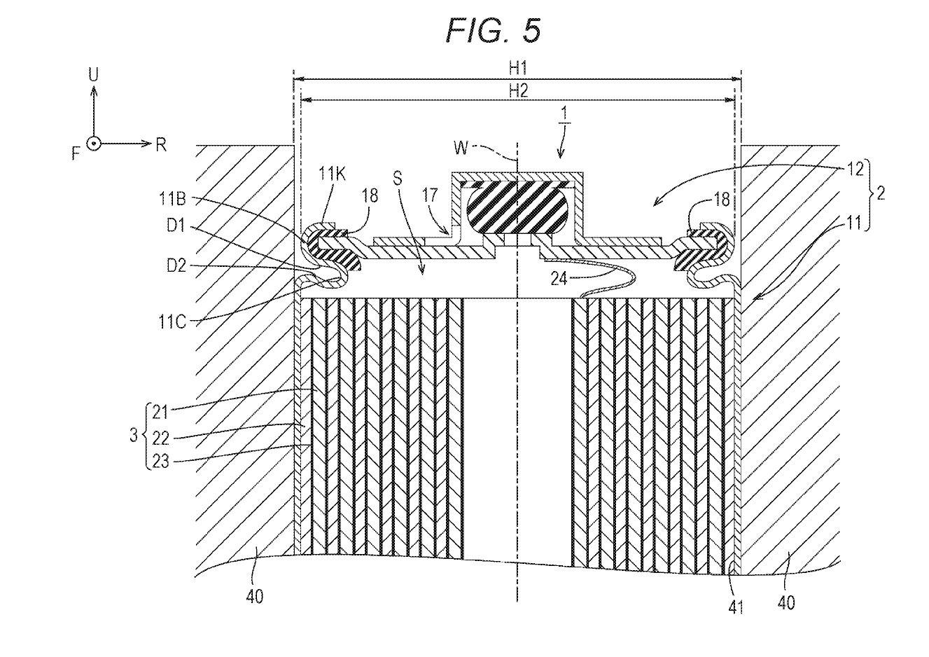

FIGS. 4 and 5 respectively show states of the case main bodies of the battery 1 and a battery 30 which is a comparative example in a diameter reducing process. The diameter reducing process is a process in which the battery 1 or 30 is press fitted. into and caused to pass through a hole 41 in a metal die 40 for the diameter reduction from the side of the sealing portion so that a diameter of the case main body is reduced to conform to a battery standardized width.

As shown in FIG. 4, an outside diameter of a sealing portion 31B of a case main body 31 of the battery 30 in the comparative example is the same as an outside diameter H1 of a body portion 31A. Therefore, in the diameter reducing process, an external force for the diameter reduction is applied not only to the body portion 31A but also to the sealing portion 31B. As a result, a caulked portion 11K of the sealing portion 31B may open upward and a sealed state may not be maintained. On the other hand, the maximum outside diameter H2 of the sealing portion 11B of the battery 1 in the embodiment is smaller than the outside diameter Hi of the body portion 11A throughout its circumference as shown in FIG. 5. Therefore, in the diameter reducing process, the external force for the diameter reduction is not applied to the sealing portion 31B. Therefore, it is possible to suppress the impossibility of maintaining the sealed state of the case main body in the diameter reducing process as compared with the battery 30.

The battery 1 has the constricted portion 11C between the body portion 11A and the sealing portion 11B. In this way, it is possible to suppress transmission of the force applied to the body portion 11A in the diameter reducing process to the sealing portion 11B as compared with a structure of a case main body 11 without a constricted portion 11C. Moreover, the wall portion D2 is inclined in such a direction as to separate from the sealing portion 11B as it extends toward the central axis W of the case main body 11 (the end portion of the body portion 11A close to the sealing portion 11B protrudes toward the sealing portion 11B at the constricted portion 11C). In this way, as compared with a structure in which a wall portion D2 is not inclined, for example, it is possible to suppress transmission of the force applied to the body portion 11A in the diameter reducing process to the sealing portion 11B. Furthermore, at least at a portion of the constricted portion 11C, the clearance between the wall portions D1 and D2 in the axial direction of the case main body 11 is such that an opening width increases toward the central axis W of the case main body 11. In this way, as compared with a structure in which an opening width of a constricted portion 11C reduces as a whole toward a central axis Z of a case main body 11, for example, it is possible to suppress transmission of the force applied to the body portion 11A in the diameter reducing process to the sealing portion 11B.

The constricted portion 11C in the embodiment is not indispensable. If an annular protruding portion protruding toward the sealing portion 11B is set to be formed at an outer peripheral edge portion as a result of a flow and escape of metal material forming the body portion 11A at one or both of the upper end portion and a lower end portion of the body portion 11A due to a compressing force acting in a radial direction on the body portion 11A in the diameter reducing process, it is similarly possible to suppress the force applied to the body portion 11A in the diameter reducing process to the sealing portion 11B.

In the method shown as an example in the above embodiment, the battery 1 is press-fitted into the hole 41 in the metal die 40 for the diameter reduction by pressing the closed portion 11D of the case main body 11 with the sealing portion 11B at the front. If the battery 1 in an opposite orientation is press-fitted into the hole 41 by pressing the lid portion 12 with the closed portion 11D of the case main body 11 at the front, it is still possible to prevent reduction in the sealing performance at the sealing portion 11B, because an outer periphery of the sealing portion 11B does not strongly rub against an inner peripheral face of the hole 41. If the battery 1 is press-fitted into the hole 41 with the closed portion 11D of the case main body 11 at the front, the axial compressing force acts on the constricted portion 11C due to resistance to the press fitting. As a result, the constricted portion 11C may be deformed and portions of the wall portions D1 and D2 of the constricted portion 11C and facing each other in the axial direction may come in contact with each other at the inlet portion of the groove shape depending on the resistance to the press fitting. If such deformation need to be avoided, the method of press-fitting the battery 1 into the hole 41 in the metal die 40 with the sealing portion 11B at the front is preferable. However, if such deformation does not become a problem, the battery 1 may be press-fitted into the hole 41 in the metal die 40 with the closed portion 11D of the case main body 11 at the front.

### Another Embodiment

The technique disclosed in the present description is not limited to the embodiment described in the above description and by using the drawings but includes various modes such as the following modes.

The “energy storage device” is not limited to the alkaline battery but may be a manganese battery, a secondary battery, or a capacitor. A shape of the “case” is not limited to a circular cylinder but may be a rectangular cylinder. The case may have a thickness of the closed portion not larger than that of the peripheral wall portion.

The case main body may not have the constricted portion and may not be in the waistless shape.

What is claimed is:

1. An energy storage device comprising:
an electrode body;
a lid portion; and
a case main body including a body portion in a shape of a container which is open on one end side and for housing the electrode body inside itself and a sealing portion for surrounding and retaining the lid portion from an outer periphery on the opening side of the body portion,
wherein an outside diameter of the sealing portion is smaller than an outside diameter of the body portion.

2. The energy storage device according to claim 1, wherein an end portion of the body portion close to the sealing portion protrudes toward the sealing portion.

3. The energy storage device according to claim 1, wherein the case main body has a groove-shaped constricted portion which has a smaller outside diameter than the body portion and the sealing portion and which is open on an outer periphery side between the body portion and the sealing portion.

4. The energy storage device according to claim 3, wherein a groove shape of the constricted portion has a portion with a larger clearance in an axial direction of the case main body on a back side than on an opening side.

5. The energy storage device according to claim 4, wherein inner wall face portions of the constricted portion facing each other in the axial direction of the case main body are in contact with each other at least at a portion.

6. The energy storage device according to claim 1, wherein the body portion has the uniform outside diameter throughout a length of the body portion.

7. An energy storage device comprising:
an electrode body;
a lid portion; and
a case main body including a body portion in a shape of a container which is open on one end side and for housing the electrode body inside itself and a sealing portion for surrounding and retaining the lid portion from an outer periphery on the opening side of the body portion,
wherein the energy storage device is manufactured by a step of forming the case main body having the sealing portion with a smaller outside diameter than an outside diameter of the body portion and
a step of press-fitting the case main body in which the electrode body is housed into a die hole for diameter reduction to reduce the diameter of the body portion and
the outside diameter of the sealing portion is smaller than the outside diameter of the body portion.

8. A manufacturing method of an energy storage device having a sealing portion with a smaller outside diameter than an outside diameter of a body portion, the method comprising the steps of
forming a case main body including a cylindrical body portion for housing an electrode body and a sealing portion for retaining a lid portion at least at one end of the body portion, the sealing portion having a smaller outside diameter than an outside diameter of the body portion and
press-fitting the case main body into a hole in a metal die for diameter reduction from a side of the sealing portion.
